(19) United States
(12) Patent Application Publication
(10) Pub. No.: US 2013/0110620 A1
(43) Pub. Date: May 2, 2013

(54) SELECTING IMAGES BASED ON TEXTUAL DESCRIPTION

(71) Applicants: Yongtai Zhu, Shanghai (CN); Bassem Elkarablieh, Mountain View, CA (US)

(72) Inventors: Yongtai Zhu, Shanghai (CN); Bassem Elkarablieh, Mountain View, CA (US)

(21) Appl. No.: 13/643,250

(22) PCT Filed: Oct. 31, 2011
(86) PCT No.: PCT/CN2011/081555

§ 371 Date: Oct. 24, 2012

(51) Int. Cl. G06Q 30/02; G06F 17/30

(52) U.S. Cl. CPC G06Q 30/0251; G06F 17/30244
USPC 705/14.49; 707/748; 707/751

(57) ABSTRACT

Methods, systems, and apparatuses, including computer programs encoded on computer readable media, for selecting images based on textual description are provided. Candidate images may be stored, for example, in an image repository. A textual description for an advertisement is received. Characteristic data, such as classification results and a feature vector, are generated based on the textual description for the advertisement. A first correlation score for each candidate image based on the characteristic data, for example, the classification results of the textual description, can be calculated. A second correlation score for each candidate image based on the characteristic data, for example, the feature vector of the textual description, can be calculated. An image can be selected from the candidate images based on the first correlation score and the second correlation score of the selected image.

### BACKGROUND

The Internet provides an opportunity for individuals, businesses, and organizations to advertise their products and services. Advertisements can be accomplished using textual descriptions alone or textual descriptions accompanied by images. In some cases, advertisements that have both textual descriptions and images may receive better advertising effects than advertisements with only textual descriptions. However, locating a suitable image that matches or is similar to the textual description of the product or service can be a lengthy and expensive process.

### SUMMARY

In one implementation, candidate images may be stored, for example, in an image repository. Candidate images may be licensed, owned, or otherwise legally acquired for use in advertisements. A textual description for an advertisement is received. Characteristic data based on the textual description for the advertisement are generated. Some examples of the characteristic data can include classification results and a feature vector. A first correlation score for each candidate image based on the characteristic data can be calculated. A second correlation score for each candidate image based on the characteristic data can be calculated. An image can be selected from the candidate images based on the first correlation score and the second correlation score of the selected image.

In one implementation, candidate images may be stored, for example, in an image repository. Candidate images may be licensed, owned, or otherwise legally acquired for use in advertisements. Advertisement data from a user interface configured to receive advertisement data are received. The advertisement data can include a textual description and a bid for an advertising campaign. Characteristic data based on the textual description for the advertisement can be generated. Some examples of the characteristic data can include classification results and a feature vector. A correlation score for each candidate image based on the characteristic data can be calculated. The correlation score may express a relationship between the candidate image and the textual description. An image can be selected based on the correlation score. The selected image can be provided to the user interface. An image advertisement including at least a portion of the textual description and a portion of the selected image can be generated. The image advertisement can be stored in an advertisement database.

Other implementations include corresponding systems, apparatuses, and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a block diagram of selecting images based on textual description in accordance with an illustrative implementation.

FIG. 2 illustrates an exemplary user interface for inputting textual description for ads in accordance with an illustrative implementation.

FIG. 3 illustrates the exemplary user interface for suggesting images in accordance with an illustrative implementation.

FIG. 4 Illustrates an image selection unit in the system in accordance with an illustrative implementation.

FIG. 5 illustrates an example of a feature vector in accordance with an illustrative implementation.

FIG. 6 is a flow diagram of a process of an image selection based on textual description in accordance with an illustrative implementation.

FIG. 7 is a block diagram of a computer system in accordance with an illustrative implementation.

### DETAILED DESCRIPTION

Advertising campaigns can be created to advertise products and/or services online. An advertising campaign can be directed to a broad product class, such as shoes. A shoe advertising campaign can include multiple advertisements related to shoes. Advertisements can be inserted into search results, web pages, mobile web pages, mobile content, games, online content, etc. An advertiser can manually enter a textual description for the product or service that she wants to advertise in a web user interface from a computer or other electronic devices.

To receive a better advertising effect, many advertisements may include images with the textual descriptions. Some advertisers can provide their own images for the advertisements. However, not all advertisers may have the resources and skills to locate suitable images. Additionally, it is possible that images provided by advertisers may create potential legal issues, such as issues related to copyrights and/or trademarks.

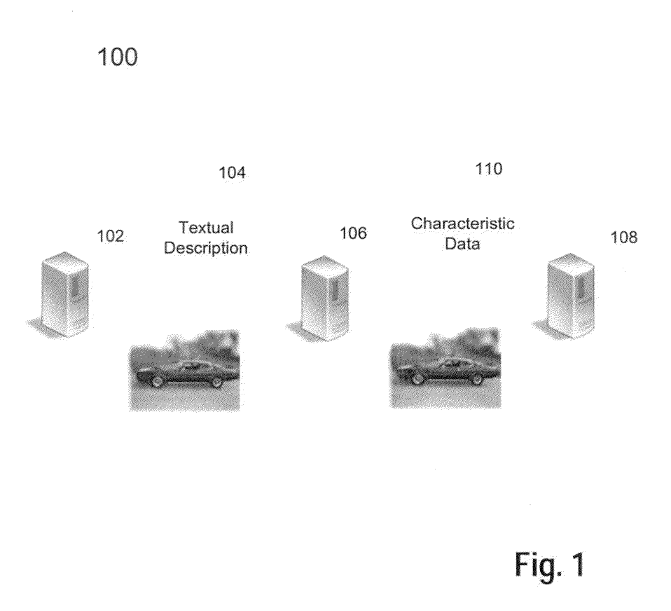

In some cases, an image may automatically be selected based on a textual description of the ad and may be presented to an advertiser. FIG. 1 illustrates a block diagram of a system of selecting images based on textual description in accordance with an illustrative implementation. In this implementation, candidate images legally owned or images whose use is legal, for example, legally purchased or licensed from third parties, may be stored in an image repository 108. Although in the illustrative example the image repository 108 is shown as a separate device from the image selection device 106, in other implementations the image repository 108 and the image selection device 106 can be considered as one device. The term “image repository” refers to the electronic storages where candidate images may be stored, including hard disk, flash drive, tape, random-access memory, read-only memory, CD-ROM, DVD, or any other kind of storage devices.

Each candidate image in the image repository may be tagged with data. For example, a candidate image can contain historical data indicating its usage information, such as whether it has been used by an advertisement, how many times it has been used by, as, or with advertisements, the textual description used in the advertisement, the performance of the image in the advertisement, such as its click through rate, etc. A candidate image can also contain a set of metadata tagged either automatically or manually indicating some information of the image. For example, a candidate image can have metadata indicating it is associated with shoes, it can be used as a gift, etc. In one implementation, the metadata of a candidate image may include tag indicating whether the image is transparent. Transparent images can have higher priority or more weight than non-transparent images because they may look better in non-white background and the objects in the transparent images are bigger, making the suggested advertisement more attractive.

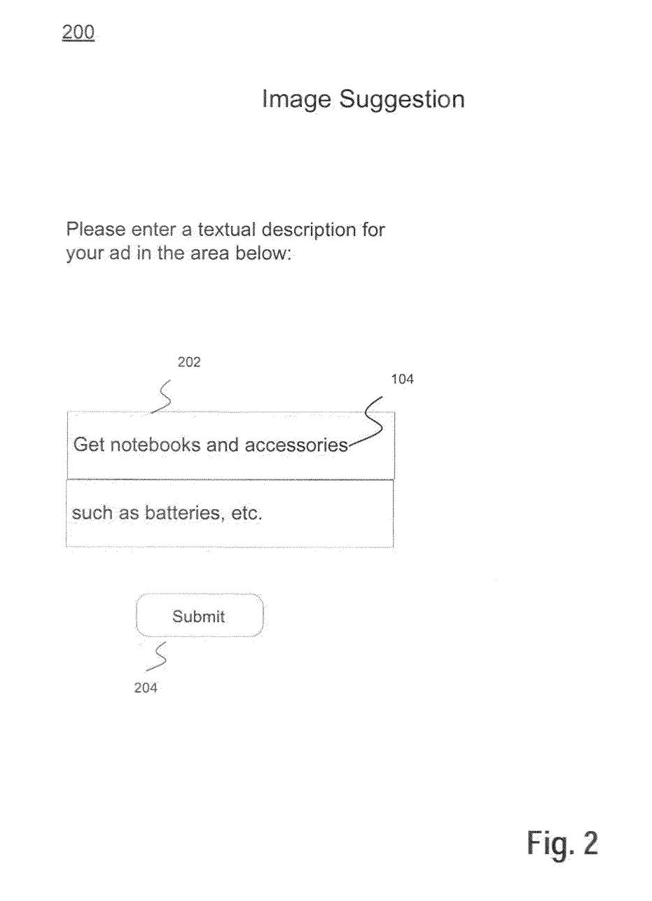

In one implementation, a client device 102 may submit advertisement data from a user interface to an image selection device 106. FIG. 2 illustrates an exemplary user interface by which a user of client device 102 may submit the advertisement data. The user interface 200 may be configured to receive advertisement data and can be displayed on a web browser running on the client device 102. User interface 200 may be part of an application running locally on a client computing device, or may be some combination of a web-based application and a local application. The application may be configured to maintain a user account for the advertiser, including for example billing information, user credentials, advertisements performance data, and other tools useful to an advertiser. The advertisement data can include a textual description of the advertisement 104 and a bid for an advertising campaign, which is not shown in FIG. 2. In FIG. 2, a text input field 202 may allow an advertiser to enter the textual description 104 for the advertiser's advertisement. A submit button 204 may allow the advertiser to submit the request.

In response to an advertiser providing textual description 104, or other text that is to be provided with an advertisement, or that characterizes or describes an advertisement, characteristic data based on the textual description may be generated. For example, image selection device 106 may analyze textual description and extract or generate characteristic data based on the textual description. The characteristic data may include, for example, classification results and a feature vector. The classification results and feature vector can form a collection of data that may be analyzed and quantified, for example to generate advertisement content based on the textual description.

To enhance an advertisement based on textual description 104, an image can be selected to form part of the advertisement. For example, an image can be selected from image repository 108. Different approaches can be used to select an appropriate image, or an image that will effectively advance an advertiser's campaign objectives. In some cases, a correlation score may be calculated for some or all available candidate images (e.g., images in image repository 108), where the correlation score for each candidate image expresses a relationship between the candidate image and the textual description. In some cases, the relationship may quantify how similar a candidate image is to the textual description. For example, if the textual description indicates a type of product or service and the candidate image relates to the same or similar type of product or service, the correlation score may define a value expressing a close relationship between the textual description and the candidate image. As another example, if the textual description contains a feature or features that are similar to a feature or features in the candidate image, the correlation score may express a close relationship between the textual description and the candidate image. To illustrate, if the textual description is associated with data indicating a color of green and a first candidate image also associated with data indicating a color of green, the correlation score may express a closer relationship than between the correlation score for the textual description and an image associated with data indicating a color of red. In some cases, the correlation score may be defined or calculated such that the closer the relationship between the textual description and the candidate image, the higher the correlation score.

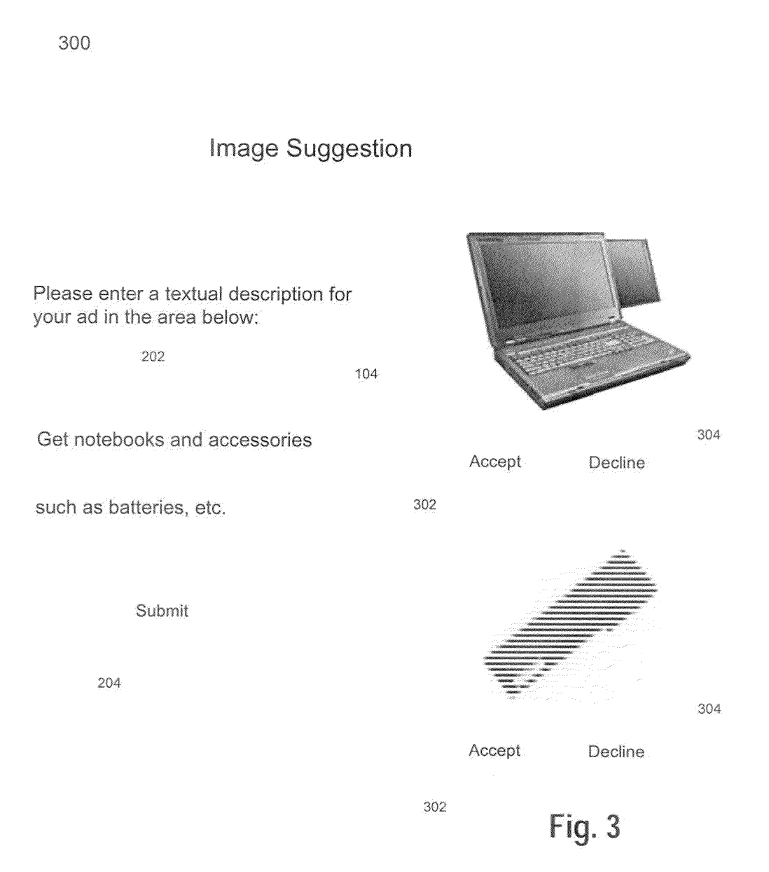

In some cases, a selected candidate image may be provided to the user interface in FIG. 3 for approval or rejection. The application or user interface may prompt the user to accept or decline the suggested image. For example, in FIG. 3, two images are returned and the advertiser may either accept or decline one or both images using the accept button 302 and the decline button 304 under each image. Although in this example two images are suggested to the advertiser, the interface can suggest only one image or more than two images. If an indication of acceptance is received from the advertiser, an image advertisement that may include at least a portion of the textual description of the advertisement and a portion of the selected image may be generated. The image advertisement may be stored in an advertisement database and may be used in an advertisement selection system, such as an advertisement auction for display alongside search results, through an advertisement display network on a publisher's web page, etc. Any suitable approach may be used to select a suggested image for use with the textual description. In one example, the image selection criteria may include taking one or more keywords from the textual description to match with keywords or tags associated with the images. As another example, a scoring algorithm may be used to rank the match results and to present one or a small number of images as suggestions to the advertiser via the user interface.

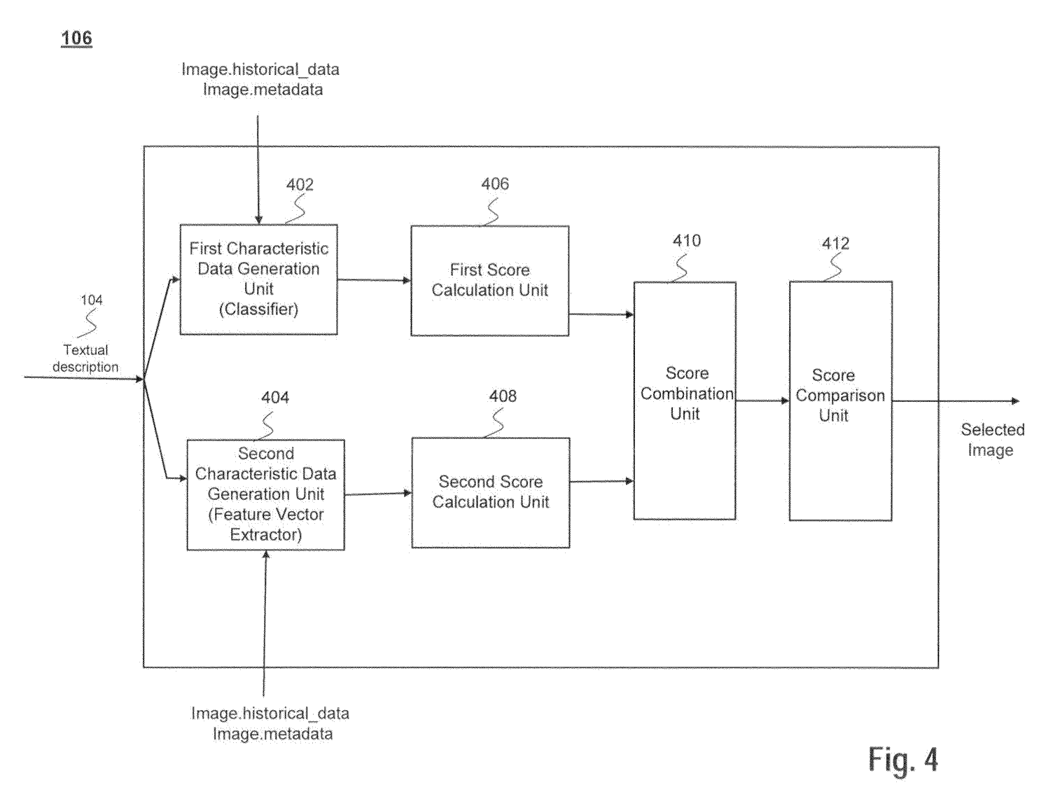

FIG. 4 illustrates one implementation of the image selection device 106. This implementation may include a first characteristic data generation unit 402, a second characteristic data generation unit 404, a first score calculation unit 406, a second score calculation unit 408, a score combination unit 410, and a score comparison unit 412. Although the first score calculation unit and the second score calculation unit are implemented as separate units in this implementation, they can be implemented as one unit in other implementations. Similarly, the score combination unit and the score comparison unit can be implemented either separately or as one unit. Moreover, any of the units illustrated in FIG. 4 may be implemented as one or more programmed portions of a processing circuit and/or memory, one or more modules, etc., in various implementations.

The first characteristic data generation unit 402 may be implemented as a classifier in this implementation. The unit 402 may take a text string as input and output one or more categories or classes or classification results for the text input. For example, if the input text string is “high-heeled shoes,” the output of the classifier 402 could be one or more categories or classes or classification results, such as boots, casual shoes, etc. The categories or classes or classification results may include predefined categories or classes or classifications of products and services stored in a memory, such as in a database. The categories or classes or classification results may be implementation-dependent. That is, different implementations can define their own categories or classes or classification results based on different criteria for classifying products and services. Unit 402 may be configured to access the database of categories or classes or classification results based on one or more strings of text in the textual description to identify and retrieve the one or more categories or classes or classification results. There could be various implementations to generate categories or classes or classification results. For example, unit 402 may break the input text into different keywords and search for synonyms of the keywords among the predefined categories in the database.

In some cases, each classification result may be associated with a weight. The weight can indicate how relevant a classification result is to the textual description. For example, the output classification result for “high-healed shoes” could be: boots with a 0.6 weight and casual shoes with a 0.2. Any suitable approach can be used to determine an appropriate weight. In some cases, weights can be determined heuristically, using historical data related to the success of particular classification results relative to textual inputs, using a learning process that makes use of advertisers approval or rejection of proposed candidate images, by structural characteristics of classification results (e.g., if classification results are organized in a tree, assign weights based on positions of results on the tree), combinations of these, or any other such approach.

The second characteristic data generation unit 404 may be implemented as a feature vector extractor in this implementation. The feature vector extractor 404 may take a text string as input and output a feature vector of the text input. A feature vector may be defined as a reduced representation set of features or a list of weighted items. A feature vector extractor can transform input data into a set of features, for example stored as a vector in a data structure. In one implementation, each feature in the feature vector may be associated with a weight. The weight of a feature may indicate how relevant or important the feature is to the input text. For example, for the input text string “high-heeled shoes,” the feature of “shoes” may be the most relevant and most important feature and therefore it may have the largest weight among the features in the feature vector (e.g., compared to colors, materials, or other types of shoes such as soccer cleats).

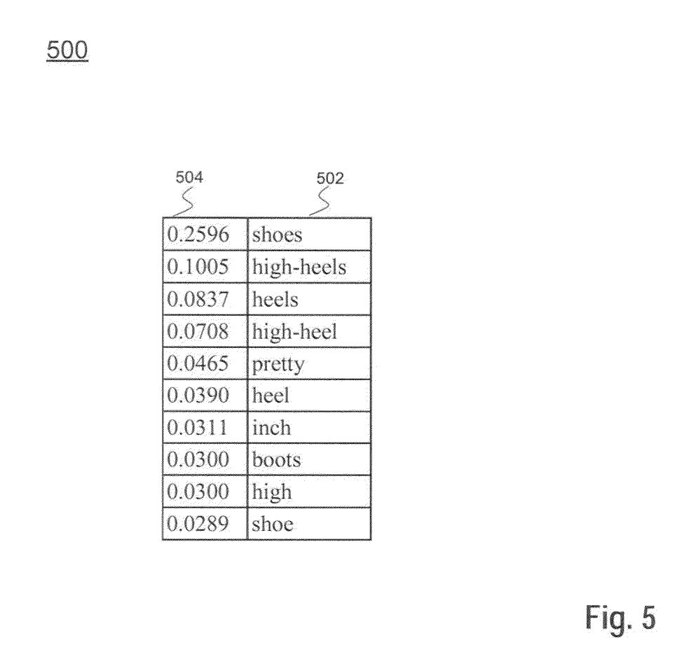

FIG. 5 illustrates a feature vector that can be extracted from the text string “high-heeled shoes.” In this example, the feature vector may include a list of features, terms or items 502, each having a corresponding weight 504. The feature vector may have at least two, at least five, less than 10, or any other number of weighted features. The feature list need not necessarily be sorted as it is in the example in FIG. 5.

In one implementation, candidate images in the image repository may be studied offline to obtain their classification results and feature vectors. Offline study in this implementation will be understood to mean that the classification and feature extraction are done prior to an advertiser submitting a textual description for an advertisement. In this particular implementation, each candidate image may be classified into one or more classification results based on its historical data or metadata using the classifier 402 in FIG. 4. The classification results obtained may be stored with their respective candidate image. Similarly, each candidate image can have its feature vectors generated offline based on its historical data or metadata using the feature vector extractor 404 in FIG. 4. The feature vectors generated may be stored with their respective candidate image. Pre-processing candidate images may be beneficial, for example, to reduce the size of the candidate image set needed for image selection at online time. For example, when an advertiser enters a textual description for an advertisement, an initial analysis of classification results and feature vectors may be performed (e.g., a threshold analysis, such as selecting the candidate images that have at least one classification result or feature in a feature vector that is in common or similar to the classification results and/or feature vectors of the textual description). This may speed up the process of retrieving appropriate candidate images and defining correlation scores for candidate images relative to the textual description. It will be understood, however, that some or all of this processing may be done in response to receiving a textual description.

In one implementation, the correlation score of a candidate image may be determined based on the categories or classification results of the candidate image's historical data. In this implementation, each candidate image that has been used in advertisements may be classified into one or more historical categories determined from the textual description of the advertisements (e.g., using classifier 402). The first score calculation unit 406 in FIG. 4 may then select a subset of the candidate images for calculating the correlation score using the historical classification categories (e.g., determined from prior advertisements). For example, the candidate images that have been used in advertisements and that are in the same category as the textual description may be selected for calculating the first correlation score. For example, if the categories or classification results of the textual description 104 “high-heeled shoes” are “boots” and “casual shoes,” the candidate images that have been used in advertisements and have the categories or classification results of boots and/or casual shoes may be selected. In this implementation, only candidate images that have actually been used in advertisements may have data available to indicate their performance, such as their click through rates. Images that have never been used may not have any data available to indicate their performance. In this implementation, by selecting a subset of candidate images, the calculation process will be faster because only a subset of the candidate images may be used. In this implementation, the first score calculation unit 406 may calculate a correlation score for each candidate image in the subset based on its historical data. For example, the more frequently the image has been used, the higher the score. As another example, the better the performance of the advertisement in which the image was used, the higher the score. The performance of the advertisement can be measured using any suitable approach including, for example, using click through rates.

In one implementation, the correlation score of a candidate image may be determined based on the categories or classification results of the candidate image's metadata. In this implementation, the metadata of each candidate image can be combined into a string. The string may then be inputted into the classifier 402 to obtain one or more classification results for the metadata of the candidate image. Each of the output classification results may be associated with a weight to indicate how relevant the metadata is to the classification result. The first score calculation unit 406 may select a subset of the candidate images for calculating the correlation score. For example, candidate images that have metadata in the same category as the textual description may be selected. For example, if the categories of the textual description 104 “high-heeled shoes” are “boots” and “casual shoes”, the candidate images that have metadata categories of boots and/or casual shoes may be selected as the subset candidate images. The first score calculation unit 406 may calculate a correlation score for a candidate image based on how relevant the classification results of the image's metadata are to the classification results of the textual description 104, for example using the weights of the classification results of the image's metadata.

In one implementation, the correlation score calculated using the classification results of the historic data of the candidate image and the correlation score calculated using the classification results of the metadata of the candidate image may be combined using the score combination unit 410 to produce a combined score. By combining the scores calculated using both the classification results of the historical data and the classification results of the metadata of the image, the resulting combined score may be a more accurate indicator of whether the image is relevant to the textual description 104. The scores may be combined using any of a number of algorithms, such as a sum, a weighted sum, a filtered or averaged sum, or other algorithms. In one implementation, the score combination unit may assign an initial weight to each score and may adjust the weight based on the image's performance result. For example, if images selected using the classification results of the historical data perform better than the images selected using the classification results of the metadata, the weight of a score associated with the historical data may be increased accordingly.

In one implementation, the correlation score of a candidate image may be determined based on the feature vector of a candidate image's historical data. The feature vectors of the candidate images that have been used in advertisements may be extracted by inputting the textual description used in the advertisement into the feature vector extractor 404. The second score calculation unit 408 may select a subset of candidate images for calculating the correlation score. For example, candidate images that have been used in advertisements may be selected as the subset candidate images. The reason that candidate images that have been used in advertisements are selected as the subset is described previously. The second score calculation unit 408 may calculate a correlation score for a candidate image in the subset of candidate images by measuring the relevancy between the features in the feature vector of the candidate image with features in the feature vector of the textual description 104. The weights of the features may be taken into consideration in calculating the score.

In another implementation, the second score calculation unit 408 may calculate a distance between the feature vector of each candidate image that has been used in advertisements and the feature vector of the textual description 104. In one implementation, a feature vector may be represented as a point in a multidimensional space. Thus, the distance between two points representing two feature vectors can be calculated. The shorter the distance, the higher the correlation score for the candidate image. In one implementation, a threshold may be applied to the calculated distances such that candidate images that satisfy the threshold are considered. The candidate images satisfying the threshold may be sorted by the distance from the feature vector of the textual description. The candidate image with the shortest distance to the textual description in terms of the feature vector may be selected (e.g., and presented to an advertiser).

The distance between two points representing two feature vectors can be calculated using a number of different formulas. One illustrative formula is the L2 Norm Distance Function. An L2 norm distance function is a Euclidean distance function that is based on the notion of distance on a plane.

Definition: If points P=(p₁,p₂, . . . , pₙ) and Q=(q₁,q₂, . . . , qₙ) are from an n-Euclidean Space, then

EuclideanDistance (P,Q) =\sqrt{(p₁-q₁)²+(p₂-q₂)²+ . . . +(pₙ-qₙ)²}

d(x,y)=square root of the sum of the squares of the differences between x and y in each dimension.

The L2 norm distance function is just an illustration and implementations are not limited to this or any other formulas.

In one implementation, the correlation score of a candidate image may be determined based on the feature vector of the candidate image's metadata. The metadata of each candidate image may be combined into a string. The string may then be inputted into the feature vector extractor 404 to obtain a feature vector for the metadata of the candidate image. The second score calculation unit 408 may select a subset of the candidate images for calculating the correlation score. For example, candidate images that have matching or similar features in their metadata feature vector with features in the feature vector of the textual description are selected. The second score calculation unit 408 may calculate a correlation score for a candidate image in the subset candidate images based on how relevant the feature vector of the candidate image's metadata is to the feature vector of the textual description. In some cases, the weights of the features may be taken into consideration. In another implementation, the second score calculation unit 408 may calculate the distance between the feature vector of the candidate image's metadata and the feature vector of the textual description 104. The calculation of the distance between two feature vectors could be done as described previously. The shorter the distance, the higher the correlation score for the candidate image.

In one implementation, the correlation score calculated using the feature vector of the historic data of the candidate image and the correlation score calculated using the feature vector of the metadata of the candidate image may be combined using the score combination unit 410 to produce a combined score. By combining the scores calculated using both the feature vector of the historical data and the feature vector of the metadata of the image, the resulting combined score may be a more accurate indicator of whether the image is relevant to the textual description 104. The scores may be combined using any of a number of algorithms, such as a sum, a weighted sum, a filtered or averaged sum, or other algorithms. In one implementation, the score combination unit may assign an initial weight to each score and may adjust the weight based on the image's performance result. For example, if images selected using the feature vector of the historical data perform better than the images selected using the feature vector of the metadata, the weight of a score associated with the historical data may be increased accordingly.

In one implementation, the correlation score calculated based on the classification results and the correlation score calculated based on the feature vector may be combined using the score combination unit 410 to produce a combined correlation score for the candidate image. As described previously, the score combination unit 410 may combine the scores using any of a number of algorithms, such as a sum, a weighted sum, a filtered or averaged sum, or other algorithms. In one implementation, the score combination unit may assign an initial weight to each score and may adjust the weight based on the image's performance results.

The score comparison unit 412 may compare the combined correlation score of a candidate image with the combined correlation scores of other candidate images and select the candidate image with the highest combined score. The selected image may be presented to the advertiser for possible use with the advertiser's text ads. In another implementation, several highly scored candidate images may be selected and presented to the advertiser to allow the advertiser to choose an image to use.

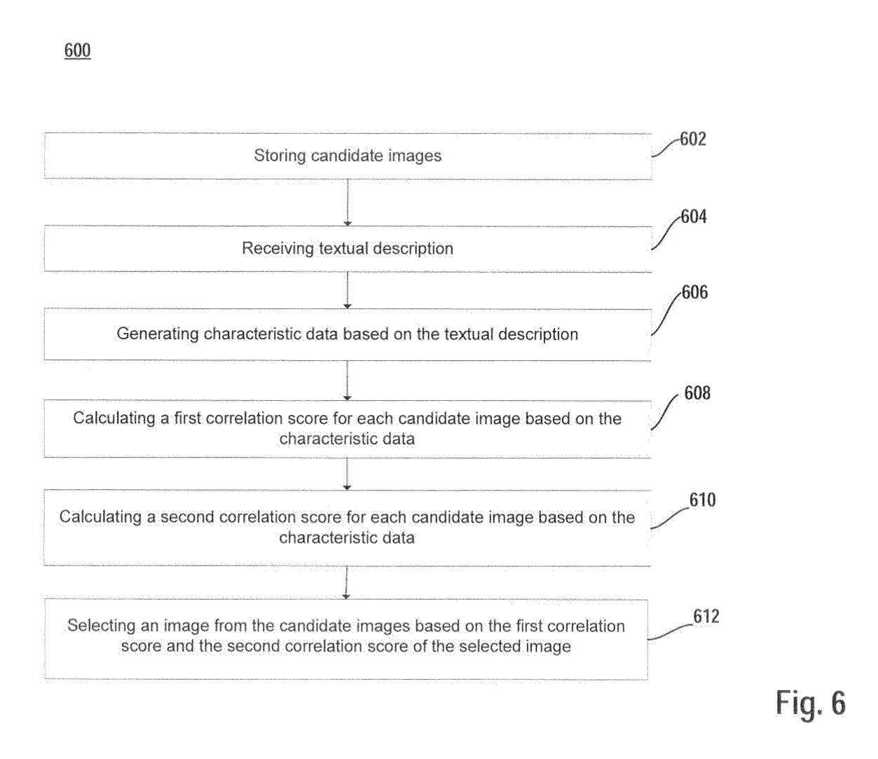

FIG. 6 is a flow diagram of a process for an image suggestion in accordance with an illustrative implementation. The process 600 can be implemented on a computing device. In one implementation, the process 600 may be encoded on a computer-readable medium that contains instructions that, when executed by a computing device, may cause the computing device to perform operations of the process 600.

The process 600 may include, at step 602, storing a plurality of candidate images. For example, images that have been legally acquired and that are available for use in advertisements may be stored in an image repository. At step 604, a textual description may be received. For example, the textual description may be received from an advertiser for an advertisement. At step 606, characteristic data based on the textual description may be generated. For example, the characteristic data may include classification results and a feature vector. At step 608, a first correlation score for each candidate image based on the characteristic data may be calculated. For example, the first correlation score may be calculated based on the classification results of the textual description. At step 610, a second correlation score for each candidate image based on the characteristic data may be calculated. For example, the second correlation score may be calculated based on the feature vector of the textual description. At step 612, an image may be selected from the candidate images based on the first correlation score and the second correlation score of the selected candidate image. For example, the first correlation score and the second correlation score of a candidate image may be combined into a combined score, and this combined score may be compared with combined scores of other candidate images to select the candidate image that has the highest score.

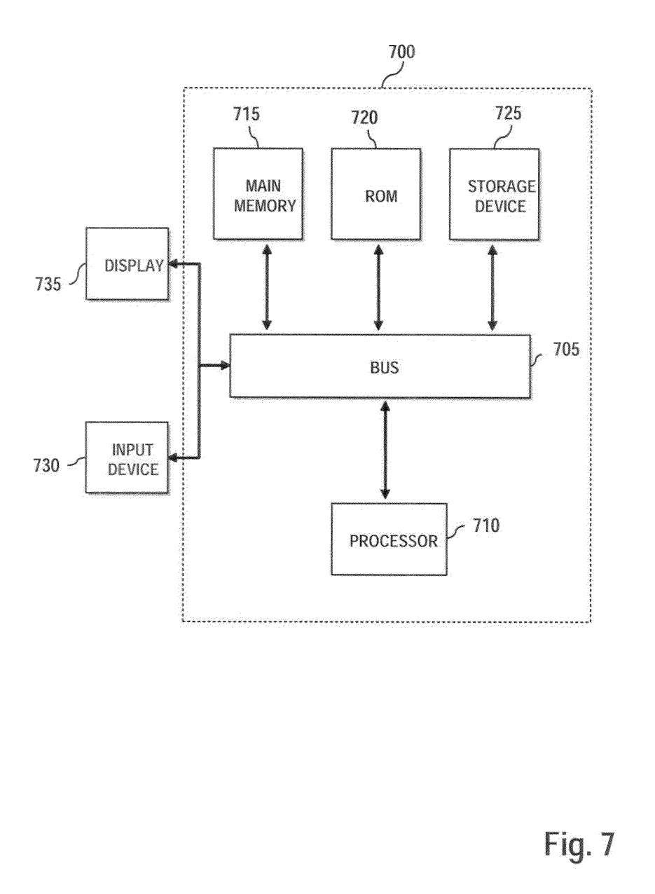

FIG. 7 is a block diagram of a computer system in accordance with an illustrative implementation. The computer system or computing device 700 can be used to implement the client device 102, the image selection device 106, and the image repository 108. The computing system 700 includes a bus 705 or other communication component for communicating information and a processor 710 or processing circuit coupled to the bus 705 for processing information. The computing system 700 can also include one or more processors 710 or processing circuits coupled to the bus for processing information. The computing system 700 also includes main memory 715, such as a random access memory (RAM) or other dynamic storage device, coupled to the bus 705 for storing information, and instructions to be executed by the processor 710. Main memory 715 can also be used for storing position information, temporary variables, or other intermediate information during execution of instructions by the processor 710. The computing system 700 may further include a read only memory (ROM) 710 or other static storage device coupled to the bus 705 for storing static information and instructions for the processor 710. A storage device 725, such as a solid state device, magnetic disk or optical disk, is coupled to the bus 705 for persistently storing information and instructions.

The computing system 700 may be coupled via the bus 705 to a display 735, such as a liquid crystal display, or active matrix display, for displaying information to a user. An input device 730, such as a keyboard including alphanumeric and other keys, may be coupled to the bus 705 for communicating information and command selections to the processor 710. In another implementation, the input device 730 has a touch screen display 735. The input device 730 can include a cursor control, such as a mouse, a trackball, or cursor direction keys, for communicating direction information and command selections to the processor 710 and for controlling cursor movement on the display 735.

According to various implementations, the processes described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special-purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
storing, in a memory device, a plurality of candidate images;
receiving, using a processing circuit, a textual description;
generating, using the processing circuit, characteristic data based on the textual description;
calculating, using the processing circuit, a first correlation score for each candidate image based on the characteristic data;
calculating, using the processing circuit, a second correlation score for each candidate image based on the characteristic data; and
selecting, using the processing circuit, an image from the plurality of candidate images based on the first correlation score and the second correlation score of the selected image.

2. The method of claim 1, wherein:
the characteristic data comprises classification results and a feature vector;
the first correlation score is based on the classification results; and the second correlation score is based on the feature vector.

3. The method of claim 1, wherein the selecting further comprises:
combining the first correlation score with the second correlation score; and
comparing the combined score of a first candidate image with combined scores of other candidate images.

4. The method of claim 2, wherein the first correlation score of the candidate image is calculated based on a relationship between historical data of the candidate image used in advertisements associated with the classification results and the textual description.

5. The method of claim 2, wherein the first correlation score of the candidate image is calculated based on a relationship between metadata of the candidate image and the textual description, wherein the metadata is associated with the classification results.

6. The method of claim 2, further comprising generating a candidate image feature vector for each candidate image, wherein the second correlation score is based on a distance between the feature vector and the candidate image feature vector for each candidate image.

7. The method of claim 6, wherein the candidate image feature vector is generated based on historical data of the candidate image.

8. The method of claim 6, wherein the candidate image feature vector is generated based on metadata of the candidate image.

9. A system comprising:
one or more processing circuits configured to:
store a plurality of candidate images;
receive advertisement data comprising a textual description;
generate characteristic data based on the textual description;
calculate, for each candidate image, a correlation score based on the characteristic data, wherein the correlation score expresses a relationship between each candidate image and the textual description;
select an image from the plurality of candidate images based on the calculated correlation score; and
generate an image advertisement comprising at least a portion of the textual description and a portion of the selected image.

10. The system of claim 9, wherein the one or more processing circuits are further configured to:
receive the advertisement data from a user interface; and
provide the selected image to the user interface.

11. The system of claim 10, wherein the one or more processing circuits are further configured to receive a confirmation to use the selected image in an image advertisement from the user interface.

12. The system of claim 9, wherein the one or more processing circuits are further configured to store the image advertisement in an advertisement database.

13. A non-transitory computer-readable medium having instructions stored thereon, the instructions comprising:
instructions to store a plurality of candidate images;
instructions to receive advertisement data comprising a textual description;
instructions to generate characteristic data based on the textual description;
instructions to calculate, for each candidate image, a correlation score based on the characteristic data, wherein the correlation score expresses a relationship between each candidate image and the textual description;
instructions to select an image from the plurality of candidate images based on the calculated correlation score; and
instructions to generate an image advertisement comprising at least a portion of the textual description and a portion of the selected image.

14. The non-transitory computer-readable medium of claim 13, further comprising:
instructions to receive the advertisement data from a user interface; and
instructions to provide the selected image to the user interface.

15. The non-transitory computer-readable medium of claim 14, further comprising instructions to receive a confirmation to use the selected image in an image advertisement from the user interface.

16. The non-transitory computer-readable medium of claim 13, further comprising instructions to store the image advertisement in an advertisement database.

17. A computer-implemented method comprising:
storing, in a memory device, a plurality of candidate images;
receiving, using a processing circuit, advertisement data from a user interface configured to receive advertisement data, wherein the advertisement data comprises a textual description and a bid for an advertising campaign;
generating, using the processing circuit, characteristic data based on the textual description;
calculating, for each candidate image, a correlation score based on the characteristic data, wherein the correlation score expresses a relationship between each candidate image and the textual description;
selecting, using the processing circuit, an image from the plurality of candidate images based on the calculated correlation score;
providing the selected image to the user interface;
generating an image advertisement comprising at least a portion of the textual description and a portion of the selected image; and
storing the image advertisement in an advertisement database.

18. The method of claim 17, wherein the characteristic data comprises classification results.

19. The method of claim 17, wherein the characteristic data comprises a feature vector.

20. The method of claim 17, further comprising receiving a confirmation to use the selected image in an image advertisement from the user interface.
